(19) United States
(12) Patent Application Publication
(10) Pub. No.: US 2007/0082518 A1
(43) Pub. Date: Apr. 12, 2007

(54) Tab assembly

(76) Inventors: Michael McDowell, Spring, TX (US); Shane Conrad, Conroe, TX (US); Mohammad Farooq, Spring, TX (US); Ralph Fuller, Conroe, TX (US); Brian Neel, Montgomery, TX (US); Todd Watrous, The Woodlands, TX (US)

Correspondence Address: Thomas N. Phung;Jacobson and Johnson, Suite 285, One West Water Street, St. Paul, MN, 55107-2080, US

(21) Appl. No.: 11/527,226

(22) Filed: Sep. 26, 2006

Related U.S. Application Data
(60) Provisional application No. 60/724,125, filed on Oct. 6, 2005.

(51) Int. Cl. H01R 4/66

(52) U.S. Cl. 439/92

(57) ABSTRACT

A snap-on tab assembly for electrically grounding a fluid separation device comprising a main body having a first surface for securing the main body to the separation device without the aid of a tool and a second surface for maintaining the main body in continuous electrical contact with the separation device and a tab extending from the main body to provide a grounding connection for discharging static electricity from the separation device.

### CROSS REFERENCE TO RELATED APPLICATIONS

This application claims priority to currently pending U.S. Provisional Application Ser. No. 60/724,125; filed on Oct. 6, 2005; titled TAB ASSEMBLY.

### STATEMENT REGARDING FEDERALLY SPONSORED RESEARCH OR DEVELOPMENT

None

### REFERENCE TO A MICROFICHE APPENDIX

None

### FIELD OF THE INVENTION

This invention relates to fluid separation systems, and more specifically to a device for electrically grounding a fluid separation device without altering the mechanical integrity or physical properties of the components of the separation device.

### BACKGROUND OF THE INVENTION

The process of fluid filtration and separation is known in the art. Generally, in the process of fluid filtration and fluid separation, a liquid or a gas to be filtered or separated is directed through a closed system generally comprising a housing having a separation device therein. The system can also include the use of various types of compressors to increase the fluid flow rate and in turn the rate of fluid separation and/or fluid filtration.

As the liquid or gas flows through the system, the liquid or gas eventually encounters the separation device, which generally comprises some type of barrier such as a filtration element. The properties of the separation device allow for the desired liquid and/or gas to pass through the separation device while preventing impurities including but not limited to various types oils, water, and solid particles from passing therethrough.

One of the problems associated with fluid separation and fluid filtration of the closed system, especially for fluids that have the potential to be volatile, is that as a stream of the fluid flows through the system, the fluid stream builds up static electricity from the velocity of the fluid as it flows through the system. If this static electricity causes an arc in the presence of a fuel source such as oxygen in the fluid stream, ignition of this fuel source can potentially occur. On such applications, grounding or continuity tabs secured to the separation devices are often used for discharging the static electricity from the separation device to prevent the arcing of the static charge thereby eliminating a potential ignition source. The grounding or continuity tabs function by providing the separation device with a path to a ground source when the separation device is attached to the closed system and is in use.

The grounding or continuity tabs on existing separation devices are commonly attached in one of two methods. The first method of grounding or continuity tabs attachment comprises the use of rivets as shown FIG. 1. The use of rivet grounding or continuity tabs requires the presence of a hole in a separation device 32, and more specifically, the end cap portion 33 of the separation device 32 and a hole in the grounding or conductivity tab 34. To secure the grounding or continuity tabs to the end cap portion of the separation device a rivet 35 is then punched into the existing holes of the end cap portion 33 of the separation device 32 and of the grounding or conductivity tab 34.

Although use of rivet grounding or continuity tabs works to properly prevent the arcing of the static charge in the closed system, one of the disadvantages of using rivet grounding or continuity tabs is that by having a hole in the separation device 32, the integrity of the separation device 32 can be compromised as the hole or holes formed by the rivet 35 can often provide an avenue for the flow of contaminants therethrough thereby reducing the effectiveness of the separation device 32. In addition, the presence of the hole(s) in the separation device 32 can also provide an avenue for the fluids being filtered or separated to escape.

The second method of grounding or continuity tabs attachment comprises welding a grounding or continuity tab 37 to a separation device 36 as shown in FIG. 2. It is noted that welding the grounding or continuity tab 37 to the separation device 36 effectively eliminates an avenue for the flow of contaminants into the separation device 36 and an avenue for the flow of fluids out from the separation device 36. However, one of the main disadvantages of the welding method is that it can alter the physical properties of the grounding or continuity tab 37 and the component of the separation device 36 in which the tab 37 has been welded to. For example, referring to FIG. 2, once welded to an end cap 38 of separation device 36, a welded portion 39 of both the grounding or continuity tab 37 and the end cap 38 of the separation device 36 becomes brittle, which can lead to the grounding or continuity tab 37 breaking off. In addition, the welded area of the end cap 38 is also more susceptible to being punctured.

There thus exists a need for a grounding or continuity tabs that can be secured to a component of the separation device without altering the mechanical integrity or physical properties of the components of the separation device or the grounding/conductivity tab while also functioning to properly achieve electrical continuity.

### BRIEF DESCRIPTION OF THE DRAWINGS

FIG. 1 shows a separation device having grounding or continuity tabs secured to an end cap of the separation device through the use of rivets;

FIG. 2 shows a separation device having grounding or continuity tabs welded to an end cap of the separation device;

FIG. 3 shows a top view of an embodiment of a grounding tab assembly that can be securely attached to an end cap of a separation device;

FIG. 3A shows a side view of the grounding tab assembly of FIG. 3;

FIG. 4 shows a top view of an alternative embodiment of a grounding tab assembly for installment to an end cap of a separation device;

FIG. 4A is a partial perspective view showing the grounding tab assembly of FIG. 4 secured to a separation device;

FIG. 5 shows an alternative embodiment of a grounding tab assembly securely attached to an end cap of a separation device;

FIG. 6 shows a top view of an alternative embodiment of a grounding tab assembly that includes a collar extending from a main body of the grounding tab assembly; and

FIG. 7 shows a cross-sectional side view of the grounding tab assembly of FIG. 6.

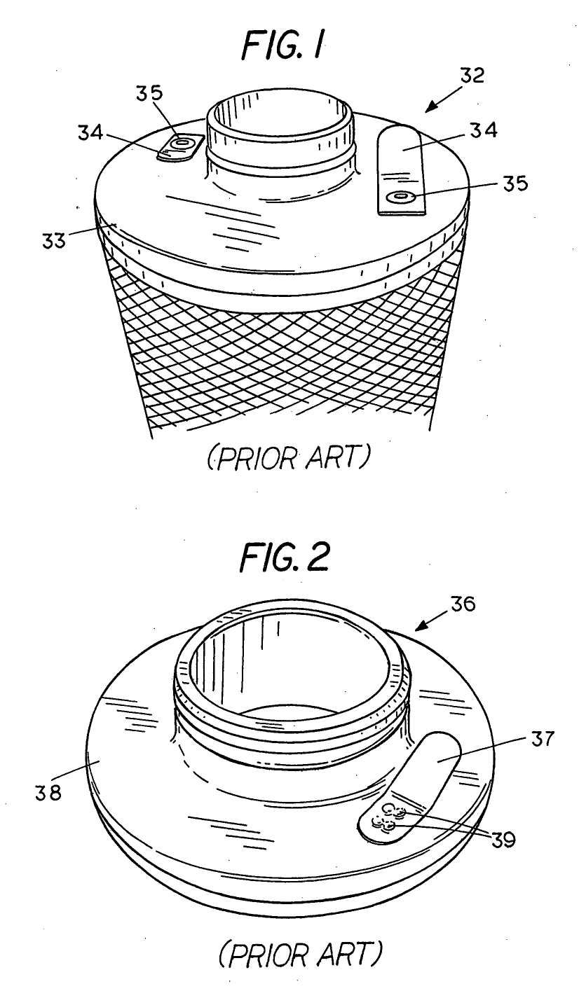

### BRIEF SUMMARY OF THE INVENTION

A snap-on tab assembly for electrically grounding a fluid separation device. The snap-on tab assembly comprises a main body having a first surface for securing the main body to a member of a separation device such as an end cap without the aid of a tool and a second surface for maintaining the main body in continuous electrical contact with a portion of the separation device. The snap-on tab assembly also includes a tab extending from the main body to provide a grounding connection for discharging static electricity from the separation device. A feature of the invention is the present invention is that the main body is installed to the end cap without altering the mechanical integrity or physical properties of the end cap or the main body. The snap-on tab assembly can further include a plurality of teeth extending from the first surface of the main body to further secure the main body to the separation device and a collar extending at an angle from the main body for mating with an exterior surface of the member of the separation device to provide a surface-to-surface frictional resistance against the detachment of the main body from the separation device.

### DESCRIPTION OF THE PRIOR ART

U.S. Pat. No. 6,245,231 teaches a filter housing that includes a bore having a conductive plug extending through the bore to provide a path for static electricity generated in the filter housing to discharge.

U.S. Pat. No. 6,921,423 teaches a separator tank assembly that includes a separator element electrically connected to a portion of the separator tank to ground the separator element and prevent a buildup of static electricity within the separator element.

### DESCRIPTION OF THE PREFERRED EMBODIMENT

The present invention comprises a grounding tap assembly that can be installed to a component of a separation device in a manner that forms a continuous electrical contact between the grounding tap assembly and the separation device without altering the mechanical integrity or physical properties of the components of the separation device or the grounding tap assembly while also functioning to properly achieve electrical continuity when the separation device is attached to the closed system and is in use.

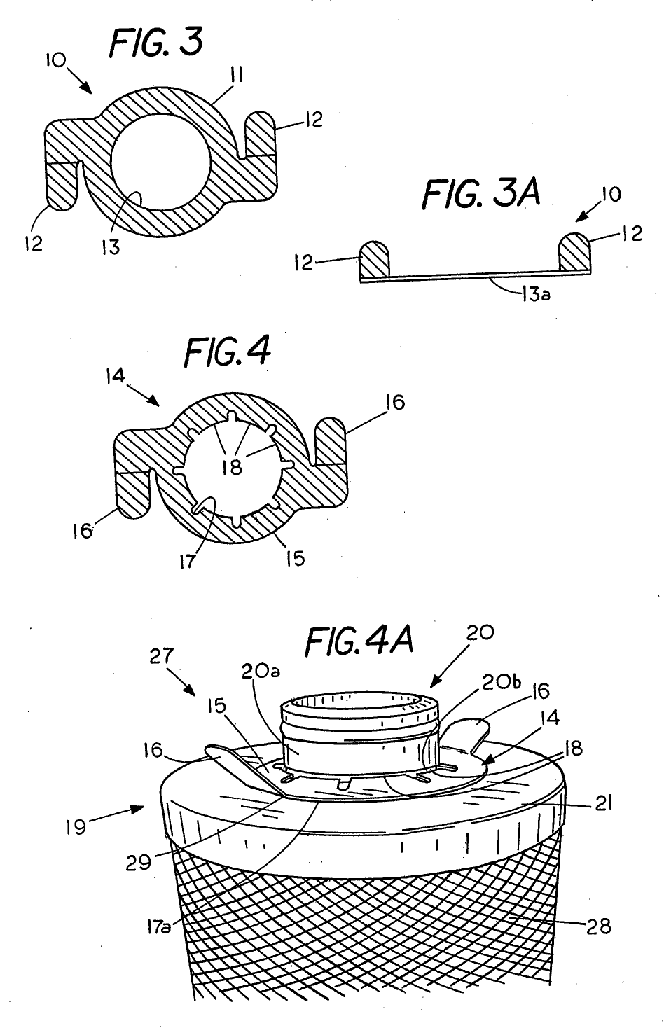

Referring to FIGS. 3 and 3A, FIG. 3 shows a top view and FIG. 3A shows a side view of an embodiment of a grounding tab assembly 10 of the present invention that can be installed to an end cap of a separation device in a press-fit manner through an interference fit between the cap and the grounding tab assembly 10 to provide for a continuous electrical contact between grounding tab assembly 10 and the end cap to prevent the arcing of the static charge in a fluid separation system when the separation device is in use. Although grounding tap assembly 10 can be made from a plurality of electrically conductive material, grounding tap assembly 10 is preferably made from a corrosion-resistant metal such as but not limited to stainless steel or aluminum. As shown in FIGS. 3 and 3A, grounding tap assembly 10 comprises a main body 11 having a pair of integral tabs 12 angularly extending from main body 11. Main body 11 of grounding tab assembly 10 includes a first surface 13 for engagable securing grounding tab assembly 10 to a protruding portion of the end cap of the separation device in a snap-on press fit manner and a second surface 13a for providing continuous contact of grounding tab assembly 10 with a base portion of the end cap of the separation device to achieve grounding or continuity without compromising the integrity or altering the physical properties of the end cap of the grounding tab assembly 10. It is noted that a feature of the embodiment of FIG. 3 and 3A is that once grounding tab assembly 10 is attached to the end cap of the separation device, surface 13 of grounding tab assembly 10 engages a surface of the end cap. By providing for an interference fit the surface-to-surface contact between surfaces 13 of grounding tab assembly 10 and the end cap provides a frictional resistance to help prevent the detachment or removal of grounding tab assembly 10 from the end cap.

Examples of some advantages of the grounding tab assembly 10 of the present invention include the installation of the grounding tab assembly 10 to the separation device without the aid of a tool and the installation of the grounding tab assembly 10 to the separation device without altering the mechanical integrity or physical properties of the components of the separation device or the grounding tap assembly while functioning to properly achieve electrical continuity when the separation device is attached to the closed system and is in use.

FIG. 4 shows a top view of an alternative embodiment of a grounding tab assembly 14 of the present invention. Grounding tab assembly 14 is similar in parts to the grounding tab assembly 10 of FIGS. 3 and 3A in that grounding tab assembly 14 includes a main body 15 having a pair of tabs 16 and a surface 17. However, grounding tab assembly 14 also includes a plurality of protrusions or teeth 18 extending from surface 17 for engagable securing grounding tab assembly 14 to a portion of the end cap of the separation device in a snap-on press fit manner without altering the mechanical integrity or physical properties of the end cap or the grounding tap assembly.

FIG. 4A is a partial perspective view showing grounding tab assembly 14 secured to a separation device 27 comprising end cap 19 and filtration element 28. Referring to end cap 19, note that end cap 19 includes a stem 20 and a base or shoulder portion 21 with stem 20 having a recess 20b located on an exterior stem surface 21a proximal shoulder 21.

In the attachment of grounding tab assembly 14 to end cap 19, grounding tab assembly 14 is aligned with end cap 19 so that the teeth 18 of grounding tab assembly 14 engage the exterior surface 20a of stem 20. End cap 19 is then pressed or driven along stem 20 towards shoulder portion 21 until a surface 17a of main body 15 comes into contact with shoulder portion 21 of end cap 19 and teeth 18 engage the recess 20b of stem 20.

It is noted that a feature of the present invention, as shown in the embodiment of FIG. 4A, is that the engagement of teeth 18 to the sidewalls of recess 20b of stem 20 securely locks grounding tab assembly 14 to end cap 19 to maintain the engagement of surface 17a of grounding tab assembly 14 to shoulder 21 to provide for a continuous electrical contact between grounding tab assembly 14 to end cap 19.

The continuous electrical contact formed between grounding tab assembly 14 and end cap 19 allows grounding tab assembly 14 to provide a path from the separation device to a ground source when the separation device is attached to the closed fluid filtration and separation system in order to discharge static electricity formed from the velocity of the fluid as it flows through the system the closed fluid filtration and separation system thereby preventing the arcing of the static charge and reducing the likelihood for potential damage. The locking engagement of grounding tab assembly 14 to end cap 19 functions to also hinder the removal of grounding tab assembly 14 from the stem 20 of end cap 19.

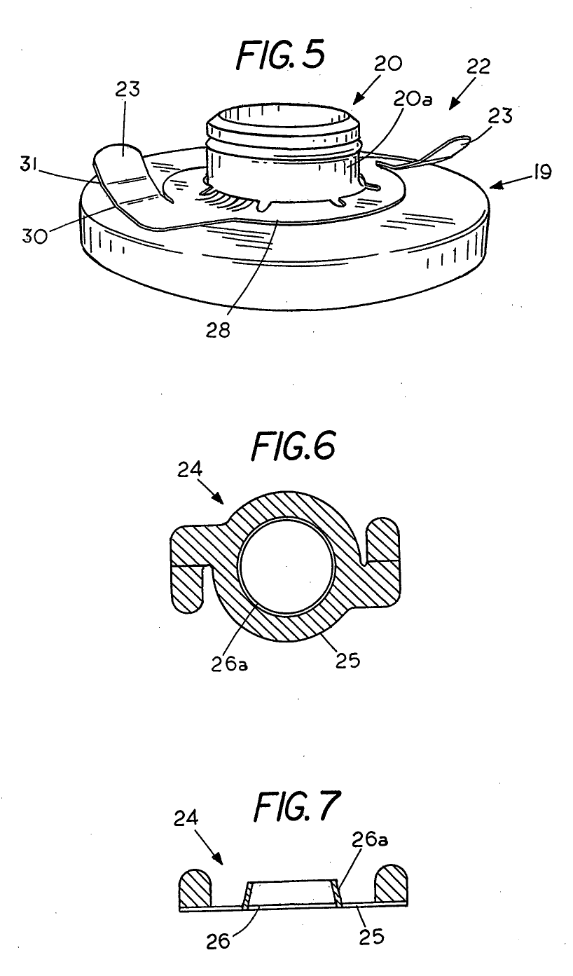

FIG. 5 shows an alternative embodiment of a grounding tab assembly 22 securely attached to end cap 19. Grounding tab assembly 22 is similar in parts to grounding tab assembly 14 of FIGS. 4 and 4A. However, unlike grounding tab assembly 14, which shows tabs 16 angularly extending or flailing from main body 15 in one angle or one curve point 29, the tabs 23 of grounding tab assembly 22 are shown extending or flailing from main body 28 in multiple angles or multiple curve points, namely curve points 30 and 31. It is noted that alternative embodiments of the grounding tab assembly of the present invention can include tabs that angularly extend in more than two angles or have more that two curve points.

Referring to FIGS. 6 and 7, FIG. 6 shows a top view and FIG. 7 shows a cross-sectional side view of an alternative embodiment of a grounding tab assembly 24 of the present invention similar to the grounding tab assembly 10 of FIGS. 3 and 3A. However, unlike grounding tab assembly 10, grounding tab assembly 24 includes a collar 26 extending from an end cap stem-engaging surface 26 at an angular direction with respect to a main body 25 of the grounding tab assembly 24. Collar 26 functions to engage the exterior stem surface 20a of end cap 19 as grounding tab assembly 24 is pressed or driven along stem 20 towards shoulder portion 21 during the attachment of grounding tab assembly 24 to end cap 19. Once grounding tab assembly 24 reaches a predetermined location on the exterior stem surface 20a of end cap 19, the engagement between the exterior stem surface 20a of end cap 19 and collar 26 provides for a surface-to-surface frictional resistance against the removal of grounding tab assembly 24 from end cap 19. The engagement between the exterior stem surface 20a of end cap 19 and collar 26 also promotes the continuous electrical contact between grounding tab assembly 24 and the end cap to prevent the arcing of the static charge in a fluid separation system when the separation device is in use.

In general regards to the grounding tab assembly of the present invention as shown in FIGS. 3, 3A, 4, 4A, 5, 6, and 7, although the above grounding tab assemblies are shown as having two (2) tabs extending from the main body of the grounding tab assembly, alternative embodiment of the present invention can comprise grounding tab assemblies having one (1) or more tabs. It is further noted that the shape of the main body of the grounding tab assembly of the present invention is not limited to circle or semi-circle and can include a plurality of alternative shapes so long as the shape of the aforementioned provides for a grounding tab assembly that can be secured to a component of the separation device without altering the mechanical integrity or physical properties of the component of the separation device or the grounding/conductivity tab while also functioning to properly achieve electrical continuity.

We claim:

1. A snap-on tab assembly for electrically grounding comprising:
a main body having a first surface for securing the main body to a separation device through an interference fit with the first surface without the aid of a tool and a second surface for maintaining the main body in continuous electrical contact with the separation device; and
a tab extending from the main body to provide a grounding connection for discharging static electricity from the separation device.

2. The snap-on tab assembly of claim 1 wherein the first surface of the main body comprises a separation device end cap stem engaging surface for securing the main body to the separation device without the aid of a tool.

3. The snap-on tab assembly of claim 1 wherein the second surface of the main body comprises a separation device end cap base engaging surface for maintaining the main body in continuous electrical contact with a portion of the separation device.

4. The snap-on tab assembly of claim 1 wherein the tab extending from the main body comprise two tab extending from the main body.

5. The snap-on tab assembly of claim 1 wherein the tab extends at an angle from the main body.

6. The snap-on tab assembly of claim 1 wherein the first surface of the main body includes a plurality of teeth extending from the first surface to further secure the main body to the separation device.

7. The snap-on tab assembly of claim 1 wherein the first surface of the main body includes a collar extending at an angle from the main body, the collar mating with a member extending from the separation device to provide a surface-to-surface frictional resistance against the detachment of the main body from the separation device.

8. The snap-on tab assembly of claim 1 wherein the tab extends from the main body in multiple angles.

9. A snap-on tab assembly for electrically continuity comprising:
a main body having a first surface for securing the main body to an end cap of a separation device without altering the mechanical integrity or physical properties of the end cap or the main body and a second surface for maintaining the main body in continuous electrical contact with a portion of the separation device; and
a tab extending from the main body to provide a grounding connection for discharging static electricity from the separation device.

10. The snap-on tab assembly of claim 9 wherein the tab extending from the main body comprises two tabs extending from the main body.

11. The snap-on tab assembly of claim 9 wherein the tab extends at an angle from the main body.

12. The snap-on tab assembly of claim 9 wherein the tab extends from the main body at multiple angles.

13. The snap-on tab assembly of claim 9 wherein the first surface comprises an end cap stem engaging surface.

14. The snap-on tab assembly of claim 9 wherein the first surface includes a plurality of teeth extending from the first surface to further secure the main body to the separation device.

15. The snap-on tab assembly of claim 13 wherein the end cap stem engaging surface includes a collar extending at an angle from the main body for mating with a portion of a stem of the end cap to provide a surface-to-surface frictional resistance against the detachment of the main body from the end cap of the separation device.

16. A snap-on tab assembly for electrically continuity comprising:
a main body having an end cap stem engaging surface for securing the main body to an end cap of a separation device through an interference fit with the end cap stem engaging surface without the aid of a tool and an end cap base engaging surface for maintaining continuous electrical contact with a portion of the end cap of separation device; and
a first tab and a second tab each extending at an angle from the main body for providing a grounding connection for discharging static electricity from the separation device.

17. The snap-on tab assembly of claim 16 wherein the end cap stem engaging surface includes a plurality of teeth extending therefrom for further securing the main body to the end cap of the separation device without the aid of a tool.

18. The snap-on tab assembly of claim 16 wherein the end cap stem engaging surface of the main body includes a collar extending at an angle from the main body for mating with a portion of a stem of the end cap to provide a surface-to-surface frictional resistance against the detachment of the main body from the end cap of the separation device.
